(19) United States
(12) Patent Application Publication
(10) Pub. No.: US 2010/0277651 A1
(43) Pub. Date: Nov. 4, 2010

(54) LIGHTING DEVICE FOR DISPLAY DEVICE, DISPLAY DEVICE AND TELEVISION RECEIVER

(75) Inventor: Mitsuhiro Takeba, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/680,214

(22) PCT Filed: Jun. 2, 2008
(86) PCT No.: PCT/JP2008/060141

§ 371 Date: Mar. 26, 2010

(30) Foreign Application Priority Data
Oct. 2, 2007 (JP) 2007-258838

(51) Int. Cl. H04N 5/44; G02F 1/13357; G02F 1/1333

(52) U.S. Cl. 348/725; 362/97.1; 349/58; 348/E05.096

(57) ABSTRACT

A lighting device 12 for a display device of the present invention includes a plurality of linear light sources 17 arranged in parallel and light source holding members 20 for holding the linear light sources 17. Each light source holding member 20 has the first member 30 and the second member 40. The first member 30 has the first light source holding portion 31 that directly holds the first linear light source 17a of the linear light sources 17. The second member 40 has the second light source holding portion 41 that directly holds the second linear light source 17b that is different from the first linear light source 17a. The light source holding member 20 is configured such that a distance between the first light source holding portion 31 and the second light source holding portion 41 can be changed by a combination of an arrangement direction of the first member 30 and the second member 40 and a permutation layout of the first member 30 and the second member 40.

### TECHNICAL FIELD

The present invention relates to a lighting device for a display device, a display device and a television receiver.

### BACKGROUND ART

A liquid crystal panel used for a liquid crystal display device such as a liquid crystal television does not emit light itself. Therefore, it requires a backlight device as a separate lighting device. The backlight device is usually disposed behind the liquid crystal panel (i.e., on an opposite side from a display surface). The backlight device includes a metal or resin chassis having an opening on a liquid crystal panel side. It also includes many fluorescent tubes (e.g., cold cathode tubes) housed in the chassis as lamps and many pieces of optical members (diffusing sheet and the like) disposed around the opening of the chassis for effectively transmitting light emitted from the lamps toward the liquid crystal panel side. It further includes lamp clips for holding the elongated tubular cold cathode tubes to the chassis. An example of such lamp clips is disclosed in Patent Document 1.

### Patent Document 1: JP-A-2006-286341

### PROBLEM TO BE SOLVED BY THE INVENTION

The lamp clips disclosed in Patent Document 1 are for positioning and supporting a plurality of fluorescent tubes behind a liquid crystal panel. Each of them has a reception portion for receiving a part of the fluorescent tube by surrounding a part of periphery of the fluorescent tube. It also has a protruding portion that becomes tangent to a part of the outer periphery of the fluorescent tube for supporting the fluorescent tube spaced apart from the inner surface of the reception portion that faces the part of the outer periphery of the fluorescent tube. To improve assembly work efficiency, one lamp clip generally has a plurality of reception portions so that one lamp clip can hold a plurality of fluorescent tubes as describe in Patent Document 1.

Such lamp clips are capable of defining arrangement patterns of lamps when they are mounted to the chassis. Because lamp holding portions are provided in fixed locations on the lamp clips, one type of lamp clips defines only one lamp arrangement pattern. Therefore, the same lamp clips cannot be used for lamps to be arranged in different arrangement patterns.

As a result, lamp clips need to be designed and manufactured exclusively for respective lamp arrangement patterns. For different lamp arrangement patterns, such as in a case that the size of liquid crystal televisions is different, different lamp clips are required according to the size. Even when the liquid crystal televisions are in the same size, the number of lamps or the lamp arrangement pattern may be different in consideration of cost and performance. In such a case, the same problem as in the above case occurs. This is very inefficient and leads to an increase in cost.

Furthermore, the lamps may not be arranged at an equal interval in one backlight device. For example, the lamps may be arranged at a small interval in a central section of the backlight device and at a large interval in end sections of the backlight device (i.e., uneven lamp pitch). In this case, different lamp clips are required for the backlight device. This leads to an increase in cost. Moreover, the lamp clips need to be sorted into different types during assembly work and the sorting is time consuming.

### DISCLOSURE OF THE PRESENT INVENTION

The present invention was made in view of the foregoing circumstances, and an object thereof is to provide a lighting device for a display device that can accommodate different arrangement intervals of the light sources and contribute to cost saving. Another object of the present invention is to provide a display device having such a lighting device and a television receiver having such a display device.

### MEANS FOR SOLVING THE PROBLEM

A lighting device for a display device of the present invention includes a plurality of linear light sources arranged in parallel and light source holding members for holding the linear light sources. Each light source holding member has the first member and the second member. The first member has the first light source holding portion for directly holding the first linear light source of the linear light sources. The second member has the second light source holding portion for directly holding the second linear light source that is different from the first linear light source. The first member and the second member are arranged along a parallel direction of the linear light sources. The light source holding member is configured such that a distance between the first light source holding portion and the second light source holding portion is variable a combination of an arrangement direction of the first member and the second member and a permutation layout of the first member and the second member.

According to such a lighting device for a display device, the distance between the first light source holding portion and the second light source holding portion can be changed by changing the arrangement direction or the permutation layout of the first member and the second member. Therefore, the distance between the light source holding portions can be set differently for one light source holding member. To change the arrangement direction, the first member and the second member are rotated on a surface parallel to a plane of the parallel arrangement of the linear light sources, for example. To change the permutation layout, locations of the first member and the second member are switched, for example. According to such light source holding members, each holding portion of which holds a different light source, the distance between the linear light sources held by the same light source holding member can be set differently. Therefore, the same light holding members can be used for the linear light sources to be arranged at different intervals, for example.

For holding linear light sources to be arranged at different intervals, design and manufacturing of the light source holding members having a plurality of light source holding portions for accommodating the different intervals are not required. For example, even if display devices require different arrangement patterns of linear light sources (or different arrangement intervals) due to different sizes, the same light holding members can be used. The distance between the first light source holding portion and the second light source holding portion can be adjusted by changing the arrangement direction or the permutation layout of the first member and the second member. Thus, the lighting device can accommodate different sizes of display devices. Even if the display devices have the same size, in consideration of cost and performance, the number of linear light sources or the arrangement patterns of linear light sources (or arrangement intervals) may be different. In such a case, the intervals of the light source holding portions can be adjusted properly by changing the arrangement direction or the permutation layout of the first member and the second member. Namely, the lighting device can accommodate such different intervals. As a result, the same light source holding members can be used regardless of the arrangement patterns of the linear light sources. This contributes to cost saving.

In one lighting device for a display device, even if the linear light sources are arranged at irregular intervals, that is, if the intervals are small in the central section of the lighting device and large in the end sections of the lighting device (irregular lamp pitch), the same light source holding members can be used. This is because the distance between the light source holding members can be adjusted for different intervals between the linear light sources. Therefore, the cost can be reduced in comparison with one that uses different light source holding members for different intervals between the linear light sources.

### BRIEF DESCRIPTION OF THE DRAWINGS

FIG. 1 is an exploded perspective view illustrating the general construction of a television receiver according to embodiment 1 of the present invention;

FIG. 2 is an exploded perspective view illustrating the general construction of a liquid crystal display device included in the television receiver illustrated in FIG. 1;

FIG. 3 is a cross-sectional view of the liquid crystal display device illustrated in FIG. 2 along the line A-A;

FIG. 4 is a plan view of a backlight device included in the liquid crystal display device;

FIG. 5 is a cross-sectional view illustrating the general construction of a lamp clip included in the backlight device;

FIG. 6 is a plan view illustrating the general construction of the lamp clip illustrated in FIG. 5 that holds cold cathode tubes;

FIG. 7 is a plan view illustrating another example of how the lamp clip illustrated in FIG. 6 is used;

FIG. 8 is a plan view illustrating still another example of how the lamp clip illustrated in FIG. 6 is used;

FIG. 9 is a cross-sectional view illustrating the general construction of a lamp clip included in a backlight device according to embodiment 2 of the present invention;

FIG. 10 is a plan view illustrating the general construction of the lamp clip illustrated in FIG. 9 that holds cold cathode tubes;

FIG. 11 is a plan view illustrating another example of how the lamp lip illustrated in FIG. 10 is used;

FIG. 12 is a cross-sectional view illustrating the general construction of a lamp clip included in a backlight device according to embodiment 3 of the present invention;

FIG. 13 is a plan view illustrating the general construction of the lamp clip illustrated in FIG. 12 that holds cold cathode tubes;

FIG. 14 is a plan view illustrating another example of how the lamp clip illustrated in FIG. 13 is used;

FIG. 15 is a plan view illustrating still another example of how the lamp clip illustrated in FIG. 13 is used; and

FIG. 16 is a plan view illustrating a modification of the lamp clip.

### BEST MODE FOR CARRYING OUT THE INVENTION

### Embodiment 1

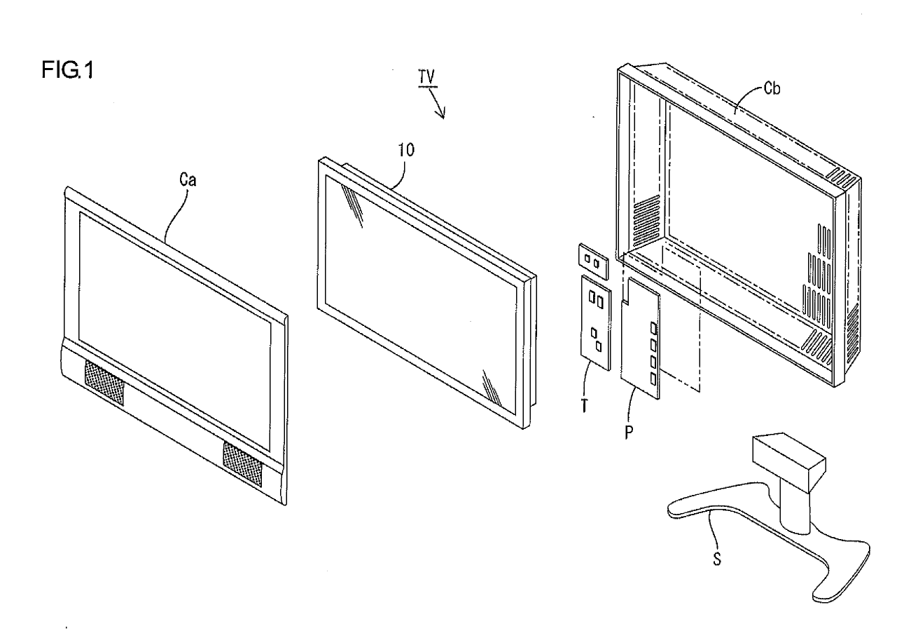

Embodiment 1 of the present invention will be explained with reference to FIGS. 1 to 8.

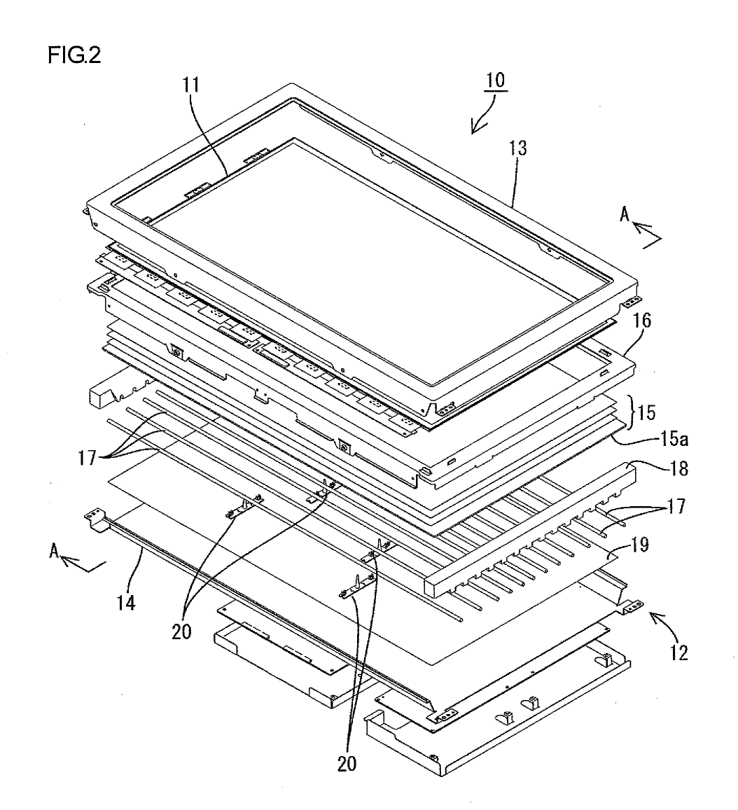

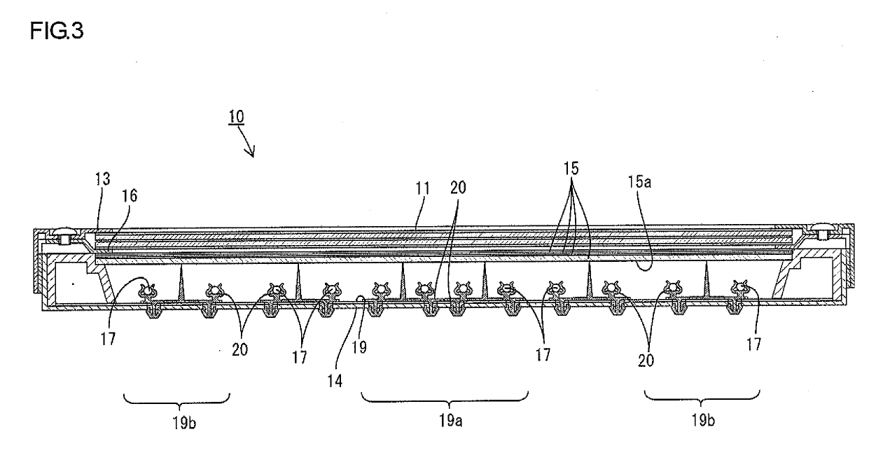

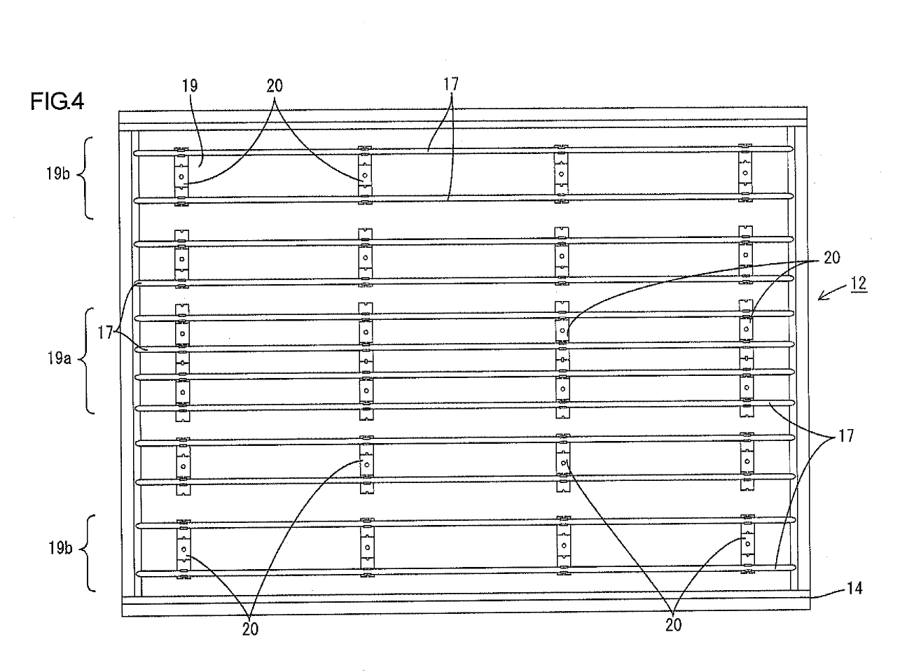

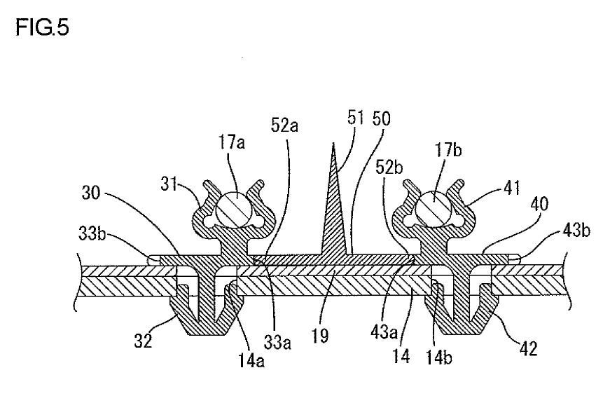

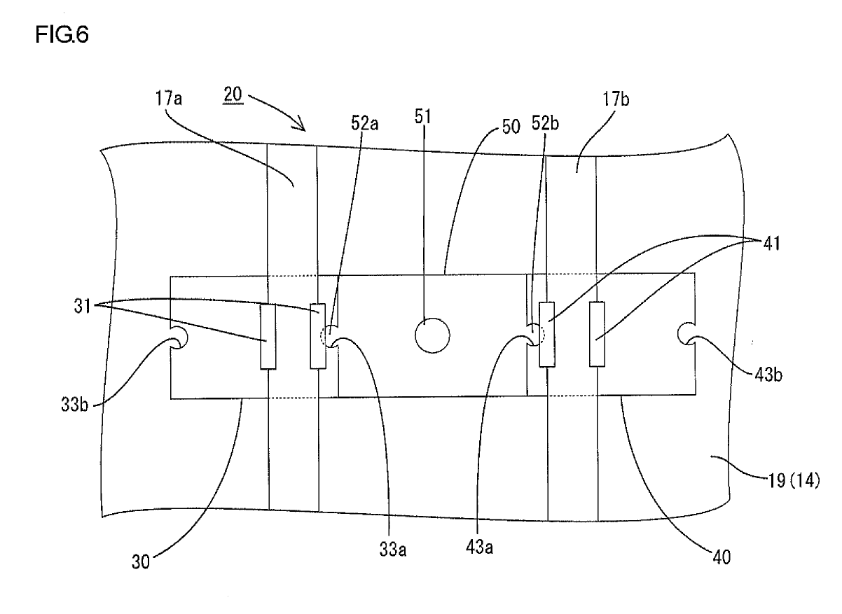

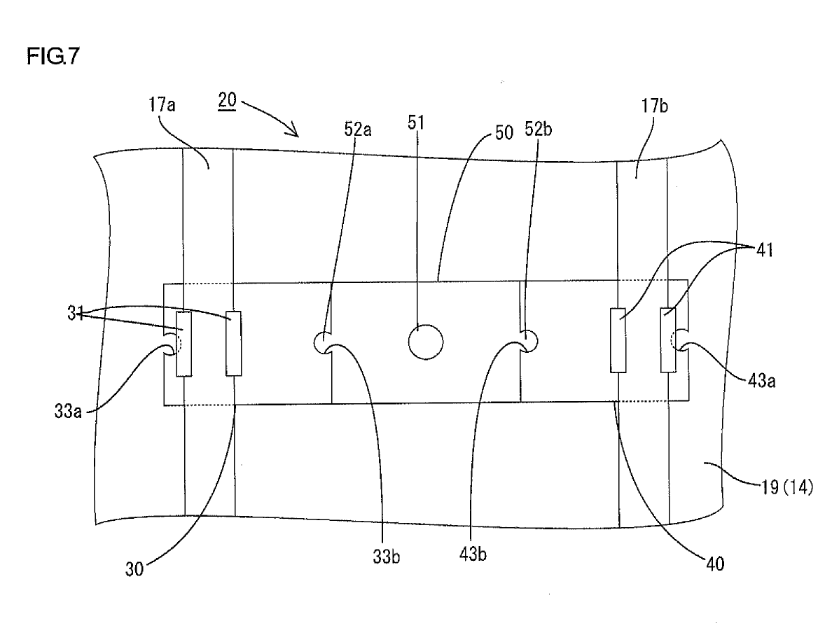

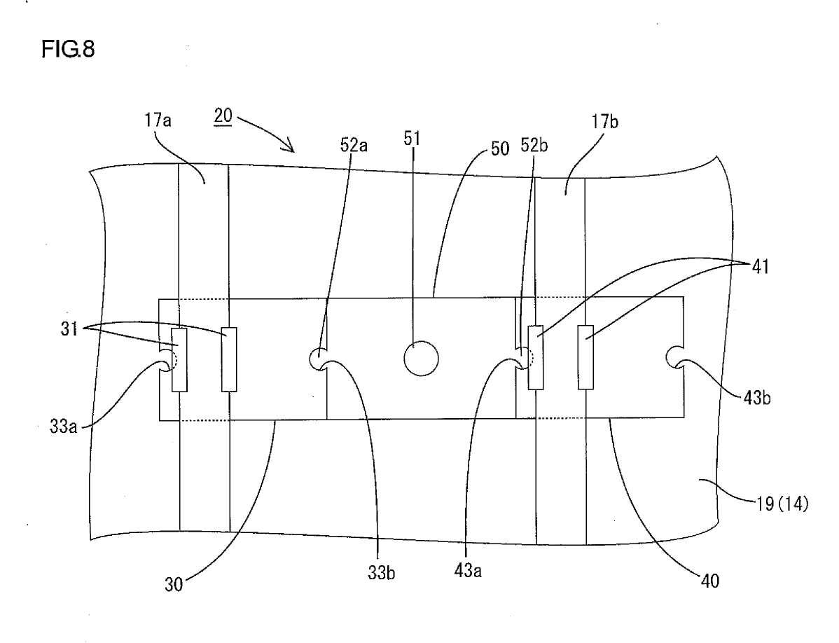

FIG. 1 is an exploded view illustrating the general construction of a television receiver according to the present embodiment. FIG. 2 is an exploded perspective view illustrating the general construction of a liquid crystal display device included in the television receiver illustrated in FIG. 1. FIG. 3 is a cross-sectional view of the liquid crystal display device illustrated in FIG. 2 along the line A-A. FIG. 4 is a plan view of a backlight device included in the liquid crystal display device. FIG. 5 is a cross-sectional view illustrating the general construction of a lamp clip included in the backlight device. FIG. 6 is a plan view illustrating the general construction of the lamp clip that holds cold cathode tubes (lamps). FIGS. 7 and 8 are plan views explaining how the lamp clips are used.

The television receiver TV of the present embodiment, as illustrated in FIG. 1, includes the liquid crystal display device (display device) 10, front and rear cabinets Ca, Cb that houses the liquid crystal display device 10 therebetween, a power source P, a tuner T and a stand S. An overall shape of the liquid crystal display device 10 is a rectangle in landscape orientation. As illustrated in FIG. 2, it includes a liquid crystal panel 11, which is a display panel, and the backlight device (lighting device for a display device) 12, which is an external light source. The liquid crystal panel 11 and the backlight device 12 are integrally held by a bezel 13 and the like.

Next, the liquid crystal panel 11 and the backlight device 12 that are included in the liquid crystal display device 10 will be explained (see FIGS. 2 and 3).

The liquid crystal panel (display panel) 11 includes a pair of glass substrates that are bonded with a predetermined gap therebetween and liquid crystal sealed between the glass substrates. On one of the glass substrates, switching components (e.g., TFTs) connected to source lines and gate lines that are perpendicular to each other and pixel electrodes and the like are disposed. On the other glass substrate, a counter electrode and color filters in which R, G, B and the like color portions are arranged in matrix are disposed.

The backlight device 12 is a so-called direct-light type backlight device. It includes a plurality of linear light sources (cold cathode tubes 17 are used as high-pressure discharge tubes here) arranged closely below an opposite surface of the liquid crystal panel 11 from the panel surface (i.e., display surface) and along the panel surface.

The backlight device 12 further includes a chassis 14, a plurality of optical members 15 (a diffuser plate 15a, a diffusing sheet, a lens sheet and a reflection type polarizing plate, arranged in this order from the lower side of the drawings) and a frame 16. The chassis 14 has a substantially box-shape and an opening on the top. The optical members 15 are arranged so as to cover the opening of the backlight chassis 14. The frame 16 holds the optical members 15 to the backlight chassis 14. The cold cathode tubes 17 and lamp clips (light source holding member) 20 for holding the cold cathode tubes 17, and lamp holders 18 that cover ends of the cold cathode tubes 17 collectively are installed in the chassis 14. A light emitting side of the backlight device 12 is a side closer to the optical member 15 than the cold cathode tube 17.

A light reflecting surface is formed on an inner surface side (light source side) of the chassis 14 with light reflecting sheet 19. With the chassis 14 including such light reflecting sheet 19, light emitted from the cold cathode tubes 17 is reflected toward the optical members 15 including the diffuser plate 15a.

The cold cathode tubes 17 are linear light sources that extend in one direction. Each of them has an elongated tubular shape. A plurality of them (twelve tubes in FIG. 2) are housed in the chassis 14 such that a longitudinal direction (i.e., axial direction) thereof is aligned with the longitudinal direction of the chassis 14 and arranged in parallel to each other. As illustrated in FIGS. 3 and 4, the cold cathode tubes 17 are arranged at a relatively small interval in a narrow pitch area 19a and at a relatively large interval in wide pitch areas 19b. The narrow pitch area 19a is located in a central section of the arrangement, that is, in a central area of the backlight device 12. The wide pitch areas 19b are located in end sections of the arrangement, that is, end areas of the backlight device 12. The cold cathode tubes 17 are fixed and held to the chassis 14 with the lamp clips 20. More specifically, arrangement intervals of the cold cathode tubes 17 gradually increase from the central section toward the end sections.

As illustrated in FIG. 4, a plurality of lamp clips 20 can be mounted on the chassis 14 so as to hold each cold cathode tube 17 at different locations in a longitudinal direction of the cold cathode tube 17. Each lamp clip 20 is generally made of synthetic resin (e.g., polycarbonate). As illustrated in FIGS. 5 and 6, the first plate member (first member) 30 and the second plate member (second member) 40 are connected to a supporting base plate (base plate portion) 50. The entire lamp clip 20 is colored in white, for example, so that it will not make a shadow by light emitted from the cold cathode tubes 17.

The supporting base plate 50 has a longitudinal plate shape when viewed in plan as illustrated in FIG. 6. A supporting pin (supporting member) 51 for supporting the diffuser plate 15a that is located in the lowermost of the optical members 15 protrudes from the center of an upper surface of the mounting plate 50 (surface facing the optical members 15). The supporting pin 51 has a round cross section when it is cut in the surface direction of the diffuser plate 15a (see FIG. 6), and has a conical shape, a diameter of which gradually decreases from its base toward its tip.

As illustrated in FIG. 6, the supporting base plate 50 has base plate tabs (base plate connecting portion) 52a, 52b formed on opposed sides. The base plate tabs are formed such that parts of the sides project outward. The supporting base plate 50 are mounted to the chassis 14 such that the base plate tabs 52a, 52b are aligned along the parallel direction of the cold cathode tubes 17. Namely, the supporting base plate 50 has the base plate tabs 52a, 52b on its either end in the parallel direction of the cold cathode tubes 17. Each base plate tab 52a, 52b has an arc shape (more specifically a major arc shape). The first plate member 30 and the second plate member 40 are connected to the supporting base plate 50 via the base plate tabs 52a, 52b.

The first plate member 30 and the second plate member 40 have rectangular shape, as illustrated in FIG. 6. As illustrated in FIG. 5, they are connected to the supporting base plate 50 with their longitudinal direction aligned to the parallel direction of the cold cathode tubes 17.

A lamp holding portion 31 (first light source holding portion) for holding the cold cathode tube 17a (first linear light source) is formed on an upper surface (a surface facing the cold cathode tube 17) of the first plate member 30 in a longitudinal end section of the first plate member 30. A lamp holding portion 41 (second light source holding portion) for holding the cold cathode tube 17b (second linear light source) is formed on an upper surface (a surface facing the cold cathode tube 17) of the second plate member 40 in a longitudinal end section of the first plate member 40. The lamp holding portions 31, 41 are formed along the parallel direction of the cold cathode tubes 17a, 17b not along the longitudinal direction of the cold cathode tubes 17.

The lamp holding portions 31, 41 can generally hold a part or an entire periphery of the cold cathode tube 17. Moreover, they have annular shapes with open ends in the upper part for allowing attachment and removal of the cold cathode tubes 17.

As illustrated in FIG. 5, stoppers 32, 42 are formed so as to protrude from the lower surfaces (surfaces facing the chassis 14, or opposite surfaces from the lamp holding portions 31, 41) of the first plate member 30 and the second plate member 40, respectively, toward the chassis 14. More specifically, the stopper 32 is formed in a central area of the first plate member 30 and the stopper 42 is formed in a central area of the second plate member 40. The first plate member 30 and the second plate member 40 are engaged in the chassis 14 by fitting the stoppers 32, 42 in mounting holes 14a, 14b formed in the chassis 14.

Further, the first blanks 33a, 33b are formed in longitudinal ends of the first plate member 30. Each of them is formed by cutting into a part of the short side of the first plate member 30. The second blanks 43a, 43b are formed in longitudinal ends of the second plate member 40. Each of them is formed by cutting into a part of the short side of the second plate member 40. Regarding the first plate member 30 and the second plate member 40, the first blank 33a and the second blank 43a are formed in the end areas in which the lamp holding portions 31, 41 are formed.

Next, how the lamp clips 20 are used will be explained with reference to FIGS. 6 to 8.

When the distance between the cold cathode tubes 17a, 17b is small, such as in the narrow pitch area 19a in FIG. 4, the lamp clips 20 illustrated in FIG. 6 are prepared. The first plate member 30 is connected to the supporting base plate 50 by fitting the base plate tab 52a formed at the end in the parallel direction of the cold cathode tubes 17 in the first blank 33a of the first plate member 30. The second plate member 40 is connected to the supporting base plate 50 by fitting the base plate tab 52b formed at the end in the parallel direction of the cold cathode tubes 17 in the second blank 43a of the second plate member 40. Regarding the first plate member 30 and the second plate member 40, the lamp holding portions 31, 41 are positioned in the end areas closer to the first blank 33a and the second blank 43a, respectively. Namely, the lamp holding portions 31, 41 are positioned in the end areas closer to the supporting base plate 50. Therefore, the distance between the lamp holding portions 31, 41 is relatively small and thus they can hold the cold cathode tubes 17a, 17b arranged at a small interval.

When the distance between the cold cathode tubes 17a, 17b is large, such as in the wide pitch area 19b in FIG. 4, the lamp clips 20 illustrated in FIG. 7 are prepared. The first plate member 30 is connected to the supporting base plate 50 by fitting the base plate tab 52a in the first blank 33b formed at the end away from the lamp holding portion 31. The second plate member 40 is connected to the supporting base plate 50 by fitting the base plate tab 52b in the second blank 43b formed at the end away from the lamp holding portion 41. The lamp holding portions 31, 41 are positioned in the end areas of the first plate member 30 and the second plate member 40 away from the supporting base plate 50. Namely, the distance between the lamp holding portions 31, 41 is relatively large and thus they can hold the cold cathode tubes 17a, 17 arranged at a large interval.

When the distance between the cold cathode tubes 17a, 17b is between that in the narrow pitch area 19a and that in the wide pitch area 19b in FIG. 4, the lamp clips 20 illustrated in FIG. 8 are prepared. The first plate member 30 is connected to the supporting base plate 50 by fitting the base plate tab 52a in the first blank 33b. The second plate member 40 is connected to the supporting base plate 50 by fitting the base plate tab 52b in the second blank 43a. The lamp holding portion 31 is positioned in the end area of the first plate member 30 away from the supporting base plate 50 and the lamp holding portion 41 is positioned in the end area of the second plate member 40 closer to the supporting base plate 50. Namely, the distance between the lamp holding portions 31, 41 is medium and thus they can hold the cold cathode tubes 17a, 17 arranged at an interval between that in the narrow pitch area 19a and that in the wide pitch area 19b.

The television receiver TV, the liquid crystal display device 10 and the backlight device 12 of the present embodiment having the above configuration provide the following operational effects.

The lamp clips 20 included in the backlight device 12 of the present embodiment can change the arrangement direction of the first plate member 30 and the second plate member 40 or the permutation layout of the first plate member 30 and the second plate member 40. The distance between the respective lamp holding portions 31, 41 of the first plate member 30 and the second plate member 40 can be changed depending on the arrangement direction or the permutation layout of the first plate member 30 and the second plate member 40.

With this configuration, the distance between the lamp holding portions 31, 41 can be set differently for one lamp clip 20. As a result, when the cold cathode tubes 17a, 17b are held by those lamp holding portions 31, 41, the distance between the cold cathode tubes 17a, 17b held by the same lamp clip 20 can be set differently. The same lamp clips can be used even when the cold cathode tubes 17 are arranged at different intervals. This contributes to cost saving.

In this embodiment, each lamp holding portion 31, 41 is formed in one end area of the first plate member 30 or the second plate member 40 rather than in a central area.

With this configuration, when the arrangement direction of the first plate member 30 and the second plate member 40 is changed, the relative locations of the lamp holding portions 31, 41 in the lamp clip 20 change. Therefore, the distance between the lamp holding portions 31, 41 changes. As a result, a single lamp clip 20 can accommodate various arrangement patterns (or arrangement intervals) of the cold cathode tubes 17.

In this embodiment, the supporting base plate 50 is provided between the first plate member 30 and the second plate member 40. The supporting base plate 50 has a supporting pin 51 for supporting the diffuser plate 15a for diffusing light emitted from the cold cathode tubes 17.

The supporting pin 51 included in the lamp clip 20 can restricts deformation of the diffuser plate 15a and thus the emitted light from the cold cathode tubes 17 is evenly diffused.

Furthermore, by providing the supporting base plate 50 between the first plate member 30 and the second plate member 40, the lamp clip 20 can accommodate various combinations of arrangement patterns of the cold cathode tubes 17. Especially by forming the supporting pin 51 on the supporting base plate 50, the supporting pin 51 in combination with the first plate member 30 or the second plate member 40 can accommodate various combinations of arrangement patterns of the cold cathode tubes 17 and supporting positions of the diffuser plate 15a.

In this embodiment, the supporting base plate 50 has the base plate tabs 52a, 52b for connecting the first plate member 30 and the second plate member 40 are formed at the ends in the parallel direction of the cold cathode tubes 17. The first plate member 30 and the second plate member 40 have the first blanks 33a, 33b and the second blanks 43a, 43b, respectively, at the ends in the parallel direction. When the base plate tabs 52a, 52b are fitted in the first blanks 33a, 33b and the second blanks 43a, 43b, the first plate member 30 and the second plate member 40 are integrated to the supporting base plate 50 to form the lamp clip 20.

By integrating the first plate member 30 and the second plate member 40 into the supporting base plate 50, the lamp clips 20 in each of which the distance between the lamp holding portions 31, 41 is set according to the arrangement pattern of the cold cathode tubes 17 can be prepared in advance. Therefore, efficiency in assembly work improves.

In this embodiment, each lamp clip 20 has the stoppers 32, 42 that can be inserted and fitted in the mounting holes 14a, 14b formed in the chassis 14 while penetrating toward the chassis 14 side.

With this configuration, the cold cathode tubes 17 are protected by the chassis 14 and the lamp clips 20 are mounted preferably to the chassis 14 with the stoppers 32, 42 engaged in the chassis 14.

In this embodiment, the stoppers 32, 42 are formed on the first plate member 30 and the second plate member 40, respectively. They protrude to a side opposite from the lamp holding portions 31, 41.

As the stoppers 32, 42 are formed on the first plate member 30 and the second plate member 40, respectively, the cold cathode tubes 17 are securely installed in the chassis 14. Moreover, because the stoppers 32, 42 protrude to the side opposite from the lamp holding portions 31, 41, the cold cathode tubes 17 can be arranged on an inner surface side of the chassis 14.

In this embodiment, the stoppers 32, 42 are formed in the center areas of the first plate member 30 and the second plate member 40, respectively.

With this configuration, when the arrangement direction of the first plate member 30 and the second plate member 40 is changed or the permutation layout of the first plate member 30 and the second plate member 40 is changed, the stoppers 32, 42 are positioned relatively in the same locations with respect to the chassis 14. As a result, the chassis 14 having the mounting holes 14a, 14b formed in a predetermined pattern can be used for different arrangements. This contributes to cost saving.

In this embodiment, a plurality of the cold cathode tubes 17 are arranged in parallel. The narrow pitch area 19a in which the arrangement interval is relatively small is located in the central section of the arrangement. The wide pitch areas 19b in which the arrangement interval is relatively large are located in the end sections of the arrangement.

By arranging the cold cathode tubes 17 such that the narrow pitch area 19a is located in the central section of the arrangement, the luminance of the backlight device 12 is enhanced in the central section of the arrangement. As a result, the visibility of the display surface of the liquid crystal display device 10 or the television receiver TV each having the backlight device 12 improves.

Furthermore, the distance between the lamp holding portions 31, 41 of each lamp clip 20 can be adjusted for different arrangement intervals of the cold cathode tubes 17. Therefore, the same lamp clips 20 can be used for supporting the cold cathode tubes 17 arranged at different intervals. As a result, the cost related to the lamp clips 20 can be saved. Moreover, the lamp clips 20 need not be sorted and thus the sorting time can be cut.

### Embodiment 2

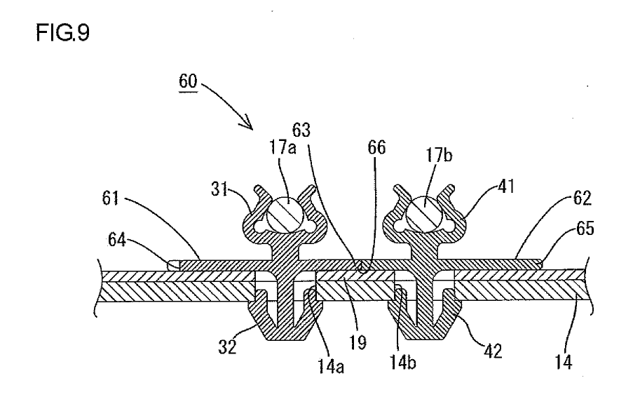

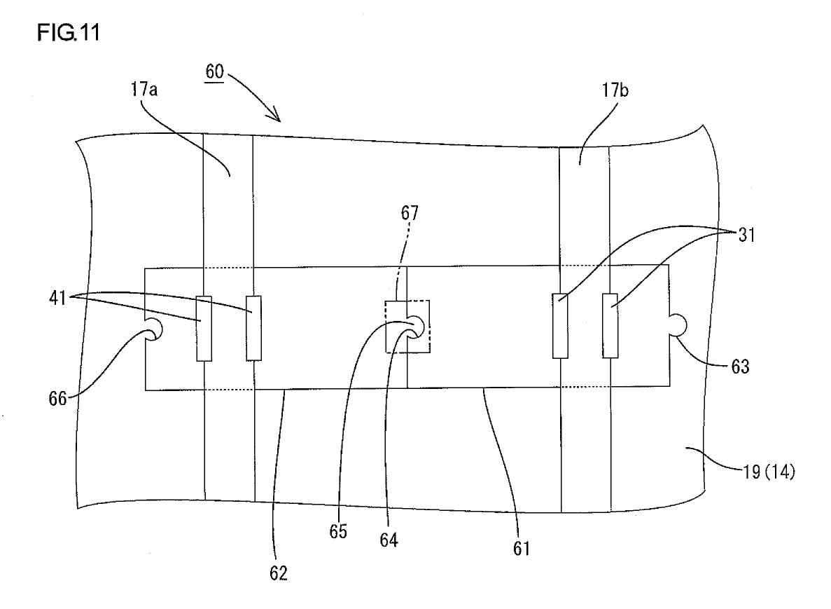

Next, embodiment 2 of the present invention will be explained with reference to FIGS. 9 and 11. In embodiment 2, the configuration of the lamp clips is different. Other configurations are the same as the previous embodiment. The same parts as the previous embodiment are indicated with the same symbols and will not be explained.

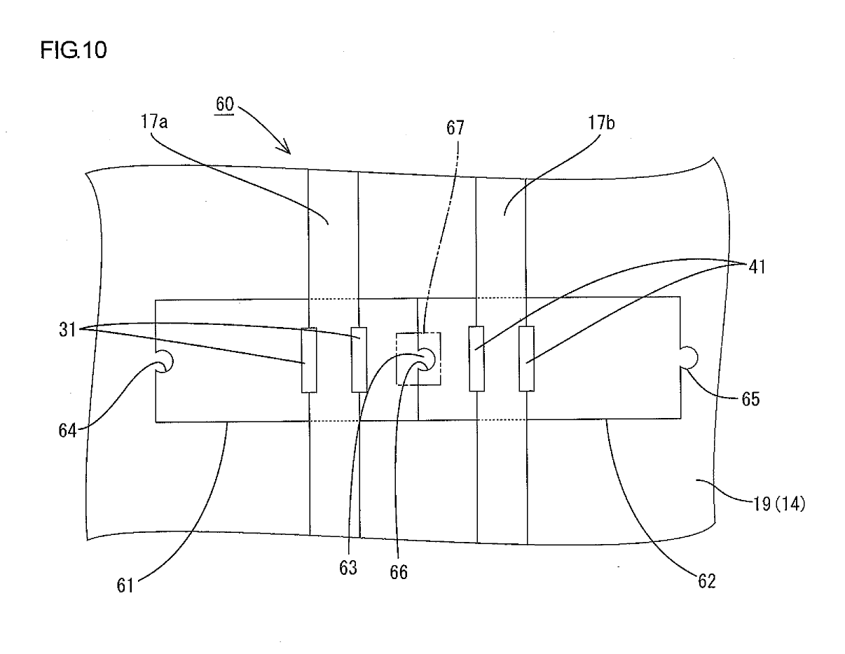

FIG. 9 is a cross-sectional view illustrating the general construction of a lamp clip included in a backlight device according to the present embodiment. FIG. 10 is a plan view illustrating the general construction of the lamp clip that holds cold cathode tubes (lamps). FIG. 11 is a plan view explaining how the lamp lip is used.

As illustrated in FIGS. 9 and 10, each lamp clip 60 has the first plate member 61 and the second plate member 62.

The lamp holding portions 31, 41 are formed on top surfaces of the first plate member 61 and the second plate member 62 (i.e., surfaces opposite from the cold cathode tubes 17) in respective longitudinal end areas for holding the cold cathode tubes 17a, 17b, respectively. The stoppers 32, 42 to be engaged in the chassis 14 are formed directly below the lamp holding portions 31, 41 (on bottom surfaces of the first plate member 61 and the second plate member 62) (see FIG. 9).

As illustrated in FIG. 10, the first tab 63 is formed such that a part of the longitudinal end of the first plate member 61 on the side closer to the lamp holding portion 31 projects outward. At the other end, the first blank 64 is formed such that a part of the end is cut into. The second tab 65 is formed such that a part of the longitudinal end of the second plate member 62 on the side away from the lamp holding portion 41 projects outward. At the end, the second blank 66 is formed such that a part of the end is cut into. The first tab 63 can be fitted in the second blank 66 and the second tab 65 can be fitted in the first blank 64.

The lamp clip 60 is mounted to the chassis 14 such that the first plate member 61 and the second plate member 62 are arranged with their longitudinal direction aligned in the parallel direction of the cold cathode tubes 17, and are connected with each other via the connecting portions 67.

Next, how the lamp clips 60 are used will be explained with reference to FIGS. 10 and 11.

When the distance between the cold cathode tubes 17a, 17b is small, the lamp clips 60 illustrated in FIG. 10 are prepared. The first plate member 61 and the second plate member 62 are connected via the connecting portions 67 having the first tab 63 and the second blank 66. The lamp holding portions 31,41 are arranged in the end area of the first plate member 61 and the second plate member 62 closer to the first tab 63 and the second blank 66. Therefore, the distance between the lamp holding portions 31, 41 is relatively small and thus they can hold the cold cathode tubes 17a, 17 arranged at a small interval.

When the distance between the cold cathode tubes 17a, 17b is large, the lamp clips 60 illustrated in FIG. 11 are prepared. The first plate member 61 and the second plate member 62 are connected via the connecting portions 67 having the first blank 64 and the second tab 65. The lamp holding portions 31, 41 are arranged in the end area of the first plate member 61 and the second plate member 62 away from each other. Therefore, the distance between the lamp holding portions 31, 41 is relatively large and thus they can hold the cold cathode tubes 17a, 17 arranged at a large interval.

Each lamp clip 60 included in the backlight device 12 of the present embodiment has the first plate member 61 and the second plate member 62. The first plate member 61 and the second plate member 62 are connected with each other via the connecting portions 67 formed at the longitudinal ends of the first plate member 61 and the second plate member 62, that is, the ends in the parallel direction of the cold cathode tubes 17.

With this configuration, the lamp clips 60 in each of which the distance between the lamp holding portions 31, 41 is set according to the arrangement pattern of the cold cathode tubes 17 can be prepared in advance. Therefore, efficiency in assembly work improves. Especially in this embodiment, the first tab 63, the second tab 65, the first blank 64 and the second blank 66 that are connectable are formed at the ends of the first plate member 61 and the second plate member 62. Therefore, they can be still connectable even when the arrangement direction or the permutation layout of the first plate member 61 and the second plate member 62 is changed.

The lamp clips 60 can change the permutation layout of the first plate member 61 and the second plate member 62. The distance between the respective lamp holding portions 31, 41 can be changed according to combination of the arrangement direction and the permutation layout of the first plate member 61 and the second plate member 62.

By changing the permutation layout of the first plate member 61 and the second plate member 62, the distance between the lamp holding portions 31, 41 can be set differently for one lamp clip 60. With each holding portion 31, 41 holding the different cold cathode tube 17a, 17b, the distance between the cold cathode tubes held by the same lamp clip 60 can be set differently.

In this embodiment, the connecting portions 67 include the first tab 63, the second tab 65, the first blank 64 and the second blank 66.

The connecting portion 67 has a simple configuration, that is, that is, formed only by fitting the first tab 63 in the second blank 66 or the second tab 65 in the first blank 64. Thus, providing the connecting portion 67 does not increase cost and only a small task is required for connecting them.

### Embodiment 3

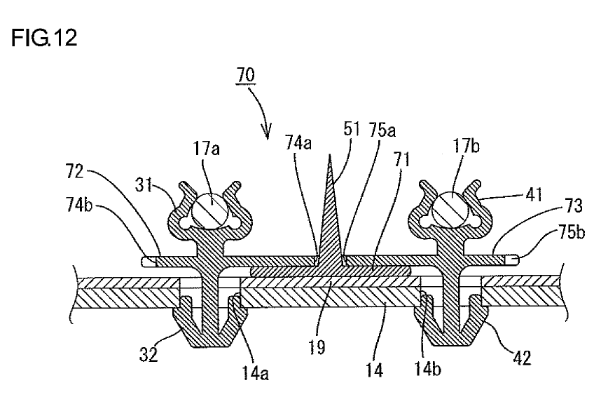

Embodiment 3 of the present invention will be explained with reference to FIGS. 12 to 15. In embodiment 3, how to connect the members is different. Other configurations are the same as the previous embodiments. The same parts as the previous embodiments are indicated with the same symbols and will not be explained.

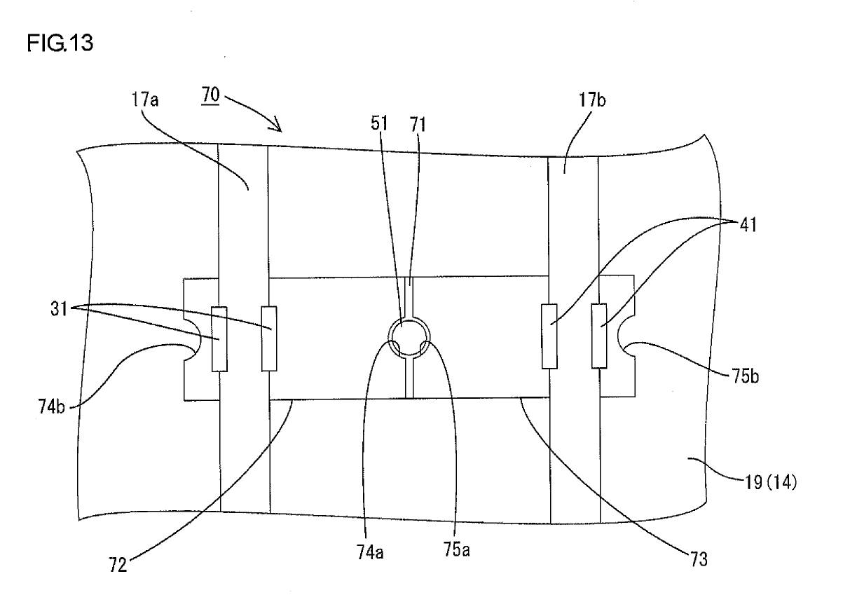

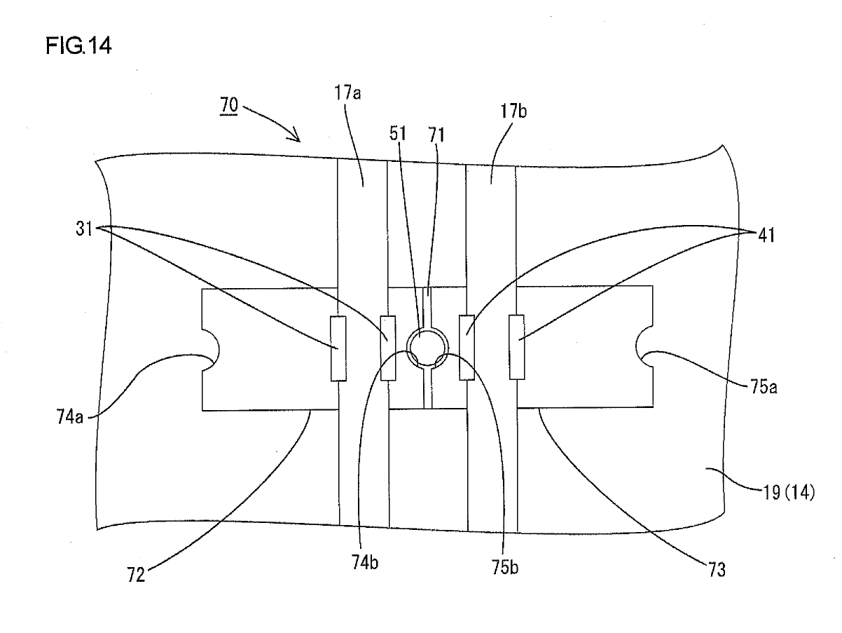

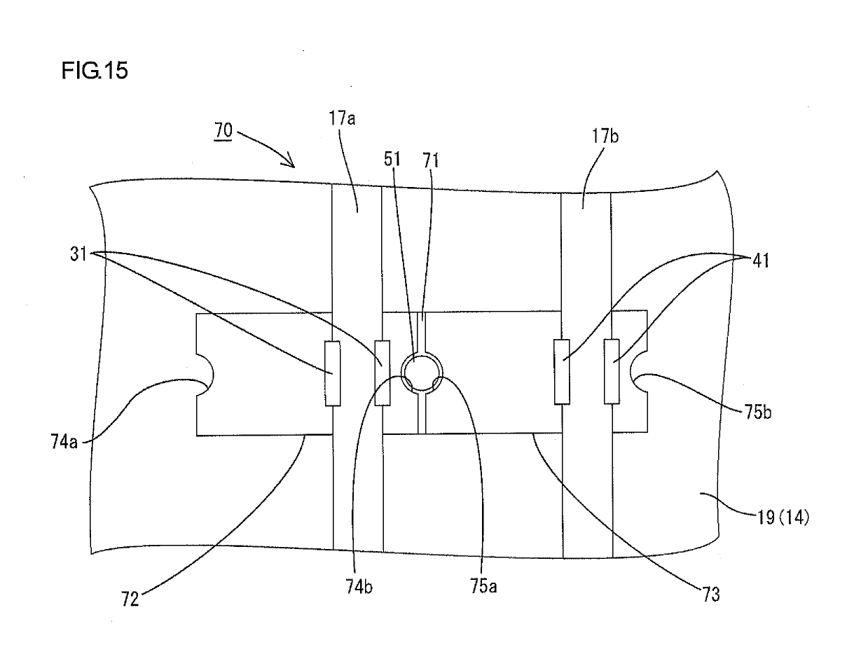

FIG. 12 is a cross-sectional view illustrating the general construction of a lamp clip included in a backlight device 12 according to embodiment 3 of the present invention. FIG. 13 is a plan view illustrating the general construction of the lamp clip that holds cold cathode tubes. FIGS. 14 and 15 are plan views illustrating how to use the lamp clip.

As illustrate in FIGS. 12 and 13, the lamp clip 70 includes a supporting base plate 71, the first plate member 72 and the second plate member 73.

The supporting base plate 71 has as a supporting pin 51 at its center and a longitudinal plate shape that extends in the parallel direction of the cold cathode tubes 17.

On upper surfaces (surfaces facing the cold cathode tubes 17) of the first plate member 72 and the second plate member 73, lamp holding portions 31, 41 for holding respective cold cathode tubes 17a, 17b are formed at one of their longitudinal ends. Stoppers 32, 42 to be engaged in the chassis 14 are formed directly below the lamp holding portions 31, 41 (lower surfaces of the first plate member 72 and the second plate member 73), respectively (see FIG. 12).

As illustrated in FIG. 13, the first blanks 74a, 74b are formed at longitudinal ends of the first plate member 72 by cutting into parts of the short sides of the first plate member 72. The second blanks 75a, 75b are formed at longitudinal ends of the second plate member 73 by cutting into parts of the short sides of the second plate member 73. The lamp holding portions 31, 41 are located in end areas closer to the first blanks 74b and the second blank 75b are formed.

As illustrated in FIG. 13, the lamp clip 70 has the first plate member 72 and the second plate member 73 arranged such that they overlap ends of the supporting base plate 71 in part, and the first blank 74a and the second blank 75a that face each other are aligned along a periphery of the base of the supporting pin 51. Moreover, they are arranged such that the supporting pin 51 is located in the first blank 74a and the second blank 75a and sandwiched by the first plate member 72 and the second plate member 73. The first plate member 72 and the second plate member 73 are engaged in the chassis 14 with the stoppers 32, 42. The supporting base plate 71 is fixed to the chassis 14 by holding power between the first plate member 72 or the second plate member 73 and the chassis 14 (the light reflecting sheet 14).

Next, how the lamp clips 70 are used will be explained with reference to FIGS. 13 to 15.

When the distance between the cold cathode tubes 17a, 17b is large, the lamp clips 70 illustrated in FIG. 13 are prepared. The first plate member 72 and the second plate member 73 are mounted to the chassis 14 such that a side having the first blank 74a and a side having the second blank 75a face each other via the supporting pin 51 that is formed at the center of the supporting base plate 71. Regarding the first plate member 72 and the second plate member 73, the lamp holding portions 31, 41 are positioned in the end areas of the first plate member 72 and the second plate member 73 closer to the first blank 74b and the second blank 75b, respectively. Namely, the lamp holding portions 31, 41 are arranged in the end areas away from the supporting pin 51. Therefore, the distance between the lamp holding portions 31, 41 is relatively large and thus they can hold the cold cathode tubes 17a, 17b arranged at a large interval.

When the distance between the cold cathode tubes 17a, 17b is small, the lamp clips 70 illustrated in FIG. 14 are prepared. The first plate member 72 and the second plate member 73 are mounted to the chassis 14 such that a side having the first blank 74b and a side having the second blank 75b face each other via the supporting pin 51 that is formed at the center of the supporting base plate 71. Regarding the first plate member 72 and the second plate member 73, the lamp holding portions 31, 41 are positioned in the end areas of the first plate member 72 and the second plate member 73 closer to the supporting pin 51, respectively. Namely, the lamp holding portions 31, 41 are arranged in the end areas closer to the supporting pin 51. Therefore, the distance between the lamp holding portions 31, 41 is relatively small and thus they can hold the cold cathode tubes 17a, 17b arranged at a small interval.

When the distance between the cold cathode tubes 17a, 17b is medium, the lamp clips 70 illustrated in FIG. 15 are prepared. The first plate member 72 and the second plate member 73 are mounted to the chassis 14 such that a side having the first blank 74b and a side having the second blank 75a face each other via the supporting pin 51 that is formed at the center of the supporting base plate 71. Namely, the lamp holding portion 31 is arranged in the end area of the first plate member 72 closer to the supporting pin 51. On the other hand, the lamp holding portion 41 is arranged in the end area of the second plate member 73 away from the supporting pin 51. Therefore, the distance between the lamp holding portions 31, 41 is set medium.

Each lamp clip 70 included in the backlight device 12 of the present embodiment has the first plate member 72 and the second plate member 73. The first plate member 72 and the second plate member 73 overlaps the ends of the supporting base plate 71 in part, and are engaged to the chassis 14 by the stoppers 32, 42.

With this configuration, the arrangement direction or the permutation layout of the first plate member 72 and the second plate member 73 can be changed. Therefore, the distance between the lamp holding portions 31, 41 can be changed according to the combination of the arrangement direction and the permutation layout. Thus, the same lamp clips 70 can be applied to different patterns of the cold cathode tubes 17.

Further, the first blank 74a of the first plate member 72 and the second blank 75a of the second plate member 73 are aligned along the periphery of the base of the supporting pin 51. Moreover, they are arranged such that the supporting pin 51 is located in the first blank 74a and the second blank 75a and sandwiched by the first plate member 72 and the second plate member 73.

With this configuration, when the first plate member 72 starts rotating due to lack of engaging force after it is engaged to the chassis 14, the supporting pin 51 comes in contact with a wall around the first blank 74a. As a result, the rotation stops. Therefore, the arrangement direction of the first plate member 72 and the second plate member 73 remains fixed once the first plate member 72 and the second plate member 73 are mounted.

### Other Embodiment

The present invention is not limited to the embodiments explained in the above description made with reference to the drawings. The following embodiments may be included in the technical scope of the present invention, for example.

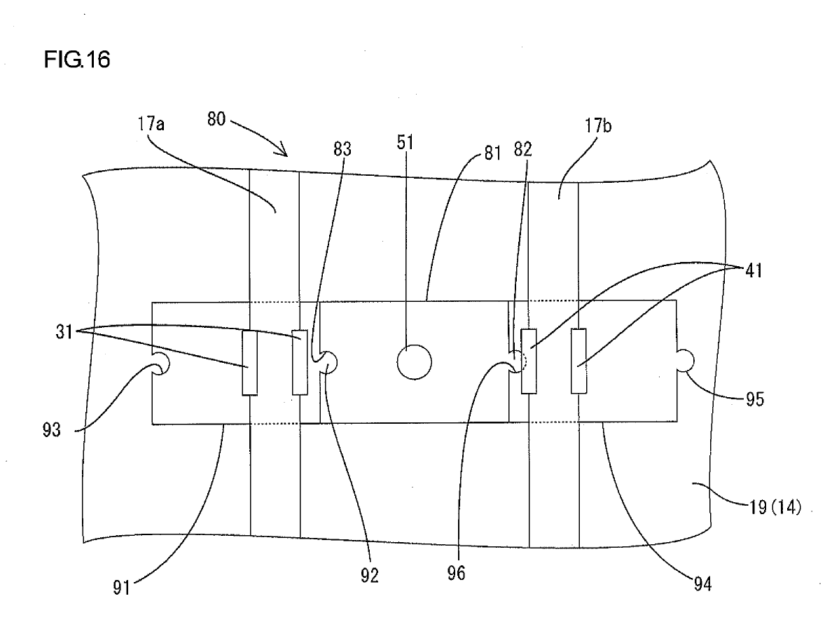

(1) In the above embodiment 1, the base plate tabs 52a, 52b are formed at the ends of the supporting base plate 50. However, lamp clips 80 illustrated in FIG. 16 may be prepared. Each lamp clip 80 includes a supporting base plate 81 having a base plate tab 82 at one end and a base plate blank 83 at the other end. The first plate member 91 and the second plate member 94 have the first tab 92 and the second tab 95 at one end, respectively, and the first blank 93 and the second blank 96 at the other end, respectively. They are connectable to the supporting base plate 81 through those. Moreover, the permutation layout of the first plate member 91 and the second plate member 94 is variable.

(2) In the above embodiment 1, the lamp clip 20 has the first plate member 30 and the second plate member 40 connected to the mounting plate 50 for holding two cold cathode tubes 17. However, the first plate member can have two or more lamp holding portions or the third plate member and the like may be connected to hold three or more cold cathode tubes 17.

In embodiment 2 that does not include the mounting plate 50, three or more cold cathode tubes 17 may be held in the same manner as above.

(3) In the above embodiment 1, the first plate member 30, the second plate member 40 and the supporting base plate 50 are connected by fitting the tabs that protrude from a part of their ends in the blanks that are cut into apart of their ends. However, they can be connected by different means. For example, they may be connected by fitting projections formed on the plate surfaces in recesses formed in the plate surfaces, or by screws.

In embodiment 2 that does not include the mounting plate 50, the connecting portion may be formed with the same means.

(4) In the above embodiments, the first plate member and the second plate member have rectangular shapes. However, they may be formed in different shapes. Moreover, the lamp clips having the first plate member and the second plate member in different shapes and sizes.

(5) In the above embodiments, the lamp clips are made of synthetic resin, and polycarbonate ones are used as examples. However, they can be made of other synthetic resin.

(6) In the above embodiments, the cold cathode tubes 17, 17 are arranged at different intervals (irregular lamp pitch). However, they may be arranged at an equal interval.

(7) In the above embodiments, the cold cathode tubes 17 are used as linear light sources. However, other types of linear light sources such as hot cathode tubes may be used.

(8) In the above embodiments, the liquid crystal display device using a liquid crystal panel as a display panel is used. However, the present invention can be applied to a display device using other types of display panels.

1. A lighting device for a display device, comprising:
a plurality of linear light sources arranged in parallel; and
a light source holding member arranged to hold said plurality of linear light sources, wherein:
said light source holding member includes a first member and a second member;
said first member has a first light source holding portion for directly holding a first linear light source of said plurality of linear light sources;
said second member has a second light source holding portion for directly holding a second linear light source that is different from said first linear light source; and
said light source holding member is configured such that a distance between said first light source holding portion and said second light source holding portion is variable by a combination of an arrangement direction of said first member and said second member and a permutation layout of said first member and said second member.

2. A lighting device for a display device, as in claim 1, wherein at least one of said first light source holding portion and said second light source holding portion is formed in an area other than a central area of said first member and said second member.

3. A lighting device for a display device, as in claim 1, wherein:
said first member and said second member include connecting portions at ends in a parallel direction of said linear light sources, respectively, so as to connect said first member and said second member each other; and
said light source holding member is constructed with said first member and said second member connected by the connecting portions.

4. A lighting device for a display device, as in claim 3, wherein:
said connecting portions include a tab and a blank;
said first member and said second member are connectable by fitting said tab included in one of said first member and said second member in said blank included in another of said first member and said second member.

5. A lighting device for a display device, as in claim 1, wherein said light source holding member further includes a base plate portion between said first member and said second member.

6. A lighting device for a display device, as in claim 5, further comprising a diffuser plate arranged to diffuse light emitted from said linear light sources on a light emitting side of said linear light sources, wherein
said base plate portion has a supporting member for supporting said diffuser plate.

7. A lighting device for a display device, as in claim 5, wherein:
said base plate portion includes a base plate connecting portion formed to connect said first member and said second member at ends in a parallel direction of said linear light sources;
said first member and said second member include a first connecting portion and a second connecting portion, respectively, at least at one of ends in the parallel direction of said linear light sources, said first connecting portion and said second connecting portion being connectable to said base plate connecting portion; and
said light source holding member is constructed with said first member and said second member integrated to said base plate portion by connecting said first connecting portion and said second connecting portion to said base plate connecting portion.

8. A lighting device for a display device, as in claim 1, further comprising a chassis in which said plurality of linear light sources are installed, wherein
said light source holding member protrudes toward said chassis and has a stopper configured to be engageable in said chassis with inserted in a mounting hole thereof.

9. A lighting device for a display device, as in claim 8, wherein:
said stopper is formed in at least one of said first member and said second member; and
said stopper protrudes toward a side opposite from said first light source holding member and said second light source holding member.

10. A lighting device for a display device, as in claim 8, wherein
said stopper is formed in a center area of each of said first member and said second member.

11. A lighting device for a display device, as in claim 1, wherein
said plurality of linear light sources are arranged in parallel at a relatively small interval in a narrow pitch area and at a relatively large interval in a wide pitch area.

12. A lighting device for a display device, as in claim 1, wherein:
said narrow pitch area is located in a central section of arrangement of said plurality of linear light sources; and
said wide pitch area is located in an end section of arrangement of said plurality of linear light sources.

13. A display device comprising:
a lighting device for a display device, as in claim 1; and
a display panel for providing display by use of light from said lighting device for a display device.

14. A display device as in claim 13, wherein said display panel is a liquid crystal panel that uses liquid crystal.

15. A television receiver comprising a display device as in claim 13.
